(19) United States
(12) Patent Application Publication
(10) Pub. No.: US 2008/0052331 A1
(43) Pub. Date: Feb. 28, 2008

(54) Data arrangement management system, method, and program

(75) Inventors: Shugo Ogawa, Tokyo (JP); Yoshihiro Kajiki, Tokyo (JP); Satoshi Yamakawa, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC Corporation, Tokyo (JP)

(21) Appl. No.: 11/880,301

(22) Filed: Jul. 20, 2007

(30) Foreign Application Priority Data
Jul. 21, 2006 (JP) 2006-199680

(51) Int. Cl. G06F 17/30

(52) U.S. Cl. 707/205; 707/E17.005

(57) ABSTRACT

An ILM device manages data arrangement in multiple storage areas to each of which a service level (called SLA), which guarantees a service level to data, is assigned, checks whether the SLA of a storage area satisfies a required service level object (SLO) of data to which the SLO is assigned, and determines the data arrangement so that the data is stored in a storage area whose SLA satisfies the SLO. A data migration execution unit migrates the data in storage based on the data arrangement determined by the ILM device.

### REFERENCE TO RELATED APPLICATIONS

The present application is claiming the priority of the earlier Japanese patent application No. 2006-199680 filed on Jul. 21, 2006, the entire disclosure thereof being incorporated herein by reference thereto.

### FIELD OF THE INVENTION

The present invention relates to data arrangement management system, and more particularly to a system, a method, and a program for arranging data in locations satisfying management conditions required individually for each piece of data when data is stored in multiple storage areas.

### BACKGROUND OF THE INVENTION

### <Hierarchical Storage Technology in Computer Memory>

Several types of devices, such as a memory or a magnetic disk, are used by a computer as storage devices. In general, the more expensive the device is, the higher the speed is.

Although a computer that processes a large amount of data at a high speed requires a large-capacity, high-speed storage device, such a computer is expensive because the cost per capacity of a high-speed storage device is high.

The hierarchical storage technology such as the one described in Non-Patent Document 1 implements less-expensive, high-speed, large-capacity storage by hierarchically laying out storage devices sequentially from high-speed, small-capacity storage devices such as cache memories to low-speed, large-capacity storage devices such as magnetic disks. According to this hierarchical storage technology, if data referenced by a program in execution is not stored in the highest-speed, small-capacity storage device (such as a cache memory), that is, if a cache miss hit occurs, the data referenced by the program is brought into the storage device by overwriting the data which is stored in the storage device and which has not been referenced for a long time.

On the other hand, the original data stored in the location in the highest-level storage device, where the referenced data is to be written, is written into a lower-level storage device as follows if the same data is not recorded on a lower-level storage device. That is, before the original data is overwritten by the referenced data, data which is stored in the lower-level storage device and which has not been referenced for a long time is selected in the same way and the original data stored in the location in the highest-level storage device, where the referenced data is to be written, is recorded in that location.

In this case, if there is a copy of the data stored in the lower-level storage device, the original data is deleted by overwriting it by the newly referenced data.

The data thrown out in this way by data from a higher-level storage device is stored again in the higher-level storage device if it is referenced again by a program thereafter.

Repeated execution of this control operation causes frequently referenced data to be stored in a higher-level, higher-speed storage device. Because the performance is influenced as data is referenced more frequently, storing frequently referenced data in a higher speed storage device implements low-cost, high-speed, and large-capacity storage.

Next, an outline of a hierarchical storage management system will be described.

### <HSM (Hierarchical Storage Management)>

As described in Patent Document 1, HSM is a management method, similar to the hierarchical storage technology in a computer memory, that migrates data among storage devices in a storage system composed of a hierarchically configured multiple storage devices to automatically optimize:
Storage usage efficiency
Cost
Performance

In HSM, data migration among storage devices is performed based on a rule specified by a manager. History information, such as the access frequency, is used as the rule. For example, when a free area is required in a storage device, less frequently accessed data is migrated to a lower-speed, lower-cost storage device. This allows data to be optimally arranged for maximum usage efficiency of the storage devices.

Next, the following generally describes ILM.

### <ILM (Information Lifecycle Management)>

According to the white paper issued by SNIA (Storage Networking Industry Association), the industry group of storage devices, ILM is defined as:

“A method for directly describing management requirements and data values for data required in the real world and for performing management tasks, by the system side, so that the management requirements established based on the description are satisfied” (Non-Patent Document 2)

The following describes an example in which data saving security requirements are used as management requirements for implementing ILM.

Various types of security are required for data handled in business as described below:
Data, such as personal information, for which strict integrated management of security is required under legal restrictions;
Data, such as in-house confidential documents, for which there is no legal restriction but security is required to prevent external access; and
Data, such as general documents, for which there is no access restriction and no security is required.

In ILM, the system side selects storage where data is recorded so that all security requirements for data are satisfied

In addition, for the storage side to satisfy the management requirements in the real world, service levels are used for the management of data and storage to represent management requirements for the data in the real world.

Patent Document 2 proposes a policy-based storage management framework that can be used both for directly connected storage and indirectly connected storage at the same time. Patent Document 2 discloses a method for defining a policy that associates data characteristics with data structures based on the correspondence between the data characteristics and the attributes defined for the data structures, for configuring each defined data structure so that the data structure provides requirements for determining storage resources for storing related data, and for configuring the defined data structure so that the data structure provides requirements for storing related data in the storage recourses.

[Patent Document 1] Japanese Patent Kokai Publication No. JP-P2001-222450A

[Patent Document 2] Japanese Patent Kohyo Publication No. JP-P2005-528688A

[Non-Patent Document 1] John L. Hennessy, David A. Patterson, “Computer Architecture”, 3rd Edition pp. 390 5. Memory Hierarchy Design, Morgan Kaufmann Publishers Inc.

[Non-Patent Document 2] “ILM Definition and Scope—An ILM Framework Internet <URL: http://www.snia.org/tech_activities/dmf/ilm/ILM_Vision_Explanation/DMF-ILM-Vision2.4.pdf>

### SUMMARY OF THE DISCLOSURE

The following analysis is given by the present invention. The entire disclosures of the above mentioned Patent Documents and Non-Patent Documents are herein incorporated by reference thereto.

ILM-based information management, when used in a system with storage devices, allows the management requirements for data required in the real world to be applied to the storage management of the system for better information management.

Although the concept of ILM has been discussed, a method has not yet been proposed for implementing the concept of ILM in actual systems.

Therefore, it is am exemplary object of the present invention to provide a system, a method, and a program for implementing the concept of ILM for which only the concept is discussed today but which is not yet implemented in an actual system.

The above and other objects are attained by the present invention which has the following general configuration. In the following description, it should be noted that a storage area includes not only a physical storage device but also a logical storage unit such as a logical volume, a directory tree, and a partition.

A data arrangement management apparatus in accordance with one aspect of the present invention manages data arrangement in a plurality of storage areas each of which has a service level (Service Level Agreement, hereinafter termed SLA) assigned, the SLA being a service level guaranteed to data. The apparatus comprises means that checks if an SLA of a storage area satisfies a required Service Level Object (hereinafter termed SLO) assigned to data and determines the data arrangement so that the data is stored in a storage area whose SLA satisfies the SLO.

In the present invention, the data arrangement management apparatus checks if an SLA of a storage area where data is stored satisfies an SLO of the data and, if the SLA does not satisfy the SLO, determines a storage area whose SLA satisfies the SLO of the data and lays out the data in the determined storage area. Alternatively, in the present invention, there is provided means for migrating the data to the determined another storage area.

In the present invention, for data which is stored in the storage area and whose SLO may not be satisfied, the data arrangement management apparatus selectively checks if an SLO of the data is satisfied in a storage area where the data is stored, based on the SLO of the data and the SLA of the storage area, and if the checking result indicates that the SLO is not satisfied, determines another storage area, which has an SLA satisfying the SLO of the data, from the plurality of storage areas, and causes data migration means to move the data from the storage area, where the data is stored, to the determined another storage area.

In the present invention, the data arrangement management apparatus further comprises means that saves information on the SLO of the data and the SLA of the storage areas.

In the present invention, if there are a plurality of storage area candidates that satisfy the SLO of the data, the data arrangement management apparatus selects one storage area from the plurality of candidates based on the SLO of the data and the SLA of the storage area.

In the present invention, the data arrangement management apparatus may further comprise means that generates a policy for migrating data so that the service level object of data is satisfied by the service level agreement of a storage area in which the data is stored.

In the present invention, for data created after the data arrangement processing performed in a storage area, data whose SLO is changed, and data whose SLO was not satisfied in the data arrangement processing in a storage area all of which are data included in the data stored in the storage areas, the data arrangement management apparatus may check if the SLA of the storage area where the data is stored satisfies the SLO of the data. According to the present invention, an invention corresponding to the device described above is also provided as a method and a program.

A data arrangement management system in another aspect of the present invention has a plurality of storage areas, which configure an HSM (Hierarchical Storage Management) implementation environment, for managing data arrangement in the plurality of storage areas via ILM (Information Lifecycle Management). The data arrangement management system comprises means that checks whether an SLO (Service Level Object) is satisfied in a storage area where data is stored, based on the SLO required by the data and an SLA (Service Level Agreement) of the storage area; means that, if the checking result indicates that there is data whose SLO is not satisfied, selects a storage area, whose SLA satisfies the SLO, as a migration destination of the data; and means that stores the data in the storage area, selected as the migration destination, when the data migration destination storage area is determined.

In the present invention, the data arrangement management system further comprises means that saves information on the SLO of the data and the SLA of the storage areas is stored.

In the present invention, data migration means provided in the HSM implementation environment is used as the means that migrates the data.

In the present invention, if other data cannot be migrated as a result of the migration of the data, the migration of the data is not canceled but a resolution of an issue that the SLO of the other data, which cannot be migrated, is not satisfied is carried over to next and subsequent data arrangement processing.

In the present invention, if a free area size of a storage area becomes equal to or smaller than a predetermined value as a result of the data re-arrangement for satisfying the SLO, data stored in the storage area is move to another storage area within a range, in which the SLO is satisfied, for reserving a free area size in the storage area.

In the present invention, whether the SLA that guarantees the service level of a storage area in which data is stored satisfies the SLO of the data is checked, wherein the data is one of data created after previous data arrangement processing, data whose SLO required by the data is changed, data stored in a storage area whose SLA is changed, and data whose SLO was not satisfied in the previous data arrangement processing.

In the present invention, if there are a plurality of storage areas having an SLA that satisfies the SLO of the data, a score is calculated based on a difference between a parameter of the SLA of the storage area and a parameter of the SLO of the data to select a storage area as the data migration destination with the score as an evaluation function.

In the present invention, the SLO has a parameter target value, which is required to be satisfied as much as possible, and/or a parameter must value which must always be satisfied and the checking of the SLA is performed separately between the parameter must value and the parameter target value of the SLO.

In the present invention, a parameter value of the SLO has an upper limit value and/or lower limit value, which can be taken by the SLO, and the checking of the SLA is performed separately between the upper limit value and the lower limit value of the SLO.

In the present invention, it is also possible to configure that, when a time required for the data arrangement processing exceeds a predetermined time, defined in advance, at a point in time, the processing is suspended by completing the processing prematurely at the point in time, only data for which the processing has been completed up to the point in time is migrated, and a migration of data that remains unprocessed because of the suspension is carried over to next and subsequent data arrangement processing.

In the present invention, it is also possible that migrated data is inhibited from being migrated to another storage destination during a predetermined period.

In the present invention, it is possible, for data stored in a predetermined storage area, to check whether or not there is a storage area having a better SLA and, if there is such a storage area, the data is migrated to the storage area having a better SLA. Alternatively, it is possible in the present invention that, for all or a part of data stored in a predetermined storage area, the storage areas other than the storage area, where the data is currently stored, is searched for another storage area that has a service level satisfying the SLO of the data and, if such an storage area is searched for, the data is migrated to the another storage area.

### <General Description of the Invention>

The following generally describes the principle of operation in the present invention.

In addition to ILM, there is a technology, called HSM, for managing data arrangement.

HSM changes the arrangement of data to increase the storage unitization when the free area size of a storage device becomes small.

ILM manages the data arrangement with no consideration for the storage sizes but, in an actual system, there is a need for managing the free storage sizes of storage devices. Therefore, the arrangement of data must be managed based on HSM that can manage free area sizes of storage devices.

The present inventors have conducted analysis on the feasibility regarding means for incorporating ILM management components into a part of an HSM policy to implement ILM, considering the fact that both HSM and ILM are management methods for changing the arrangement of data.

The conclusion is that ILM cannot be implemented on the HSM management base because of the following reasons.

HSM determines the data storage locations based on the following factors that are not related to the contents of data.
Creation date of data;
Last accessed date; and

Access frequency of data.
The migration of data depends on a change in the free area size in the storage devices.

By contrast, ILM determines the storage location of data based on the contents of the data.

In ILM, the criteria for determining the storage location of data do not include:
Criteria for determining storage locations; and
Storage requirements for migrating data.

Thus, on the HSM management base, it is impossible to implement ILM, for which only the concept is discussed, as a part of an HSM policy.

The following describes more in detail the study conducted by the inventor of the present invention and his colleagues (Note that none of the configurations described below are proposed as a conventional technology).

To implement ILM, it is necessary for the system to have a management base, which migrates data to a storage device where the management requirements are satisfied, independently of the HSM management base.

HSM manages data arrangement with focus on free area size and performance of storage, while ILM manages data arrangement with focus on contents of data.

As described above, HSM and ILM have respective management functions independent of each other and, so, the management with focus on characteristics of both storage and data requires that HSM management base and ILM management base coexist.

The study of the technology for the coexistence, described below, is an absolutely new technology developed by the inventors of the present invention.

To implement the coexistence of HSM and ILM, it is necessary to use ILM management base compatible with off-the-shelf HSM management base.

As described above, HSM and ILM differ in
Criteria for determining data arrangement; and
Factors for starting migration of data.

### This difference makes it impossible for ILM to be implemented on the HSM management base.

Therefore, the implementation of ILM requires that, in addition to the management by HSM, the locations of all managed data be determined in such a way that the service level object required by the data is satisfied by the service level guaranteed by the storage area in which the data is stored.

One of the problems with this method is that the size of a storage area where data is stored is limited. This means that, if the arrangement of managed data is determined sequentially so that the requested service object is satisfied, the data whose arrangement is determined earlier is stored earlier in a storage area where its service object is satisfied. This may lead to a situation in which the free storage area of the same storage area becomes insufficient when data whose arrangement is determined later is stored, sometimes preventing the data, whose arrangement is determined later, from being stored in that storage area even if the requested service object is satisfied.

As described above, the arrangement processing for some data sometimes affects the arrangement processing for other data. Therefore, to locate entire pieces of data so that the entire pieces of data satisfy all management requirements satisfying the service objects requested for management, it is necessary to verify all possible arrangement combinations for the entire pieces of data.

Because the number of the combinations is proportional to a number calculated by power of the number of managed storage areas with the number of pieces of managed data as an exponent, the amount of calculation for determining the locations according to the method described above is proportional to the number of combinations of locations of entire pieces of data. So, the number of times the SLO is evaluated is k^{N}, where K is the total number of storage areas and N is the total number of data pieces. This calculation time is too long to be practical.

Therefore, ILM cannot be implemented by this method.

To solve this problem, the present invention provides a technique that allows storage management by the existing HSM and information management by ILM to coexist in the same system so that they can be used at the same time.

With the technique according to the present invention, the amount of calculation required for determining the arrangement satisfying the service levels required by entire pieces of data is reduced and it has been made possible to determine the arrangement of data within a practical calculation time.

With the technique according to the present invention, entire pieces of data are not subjected to location change, which is for satisfying SLOs for implementing ILM, but only the following data are changed in locations.
Data whose SLO is not satisfied
Created data

### This technique can determine the arrangement of entire pieces of data, which satisfies the SLOs, within a time that does not depend on the total number of data pieces.

In addition, with the technique according to the present invention, a combination of the locations of all managed data is not derived but the location of each piece of data whose location is changed is independently determined and, even if the determined location influences the location of other data, does not change the location of data that is once determined. Therefore, the number of times the SLO evaluated is reduced from
(The power of (Total number of storage areas) with (Total number of data pieces as an exponent)) (=K^{N}) to
(Number of data pieces whose SLO is not yet satisfied or which is created (=n))×(Total number of storage areas (=K^{N})) (=K×n)

With the technique according to the present invention, the calculation time can be significantly reduced, especially when the number of data pieces is increased.

Furthermore, if there is data whose SLO is not satisfied in the arrangement processing executed immediately before, the solution is carried over to the next and the following processing. Therefore, the technique according to the present invention does not take long in each operation of processing and reduces the processing time of each operation.

A data arrangement management system according to the present invention, which has multiple storage areas configuring an HSM (Hierarchical Storage Management) implementation environment, manages the data arrangement via ILM (Information Lifecycle Management), where SLA (Service Level Agreement) that is the service level of a storage area guaranteed by the storage area and SLO(Service Level Object) that is the object of a service level required by data are used. This data arrangement management system has a function that checks whether SLO of data is satisfied by SLA of a storage area where the data is stored. That is, the data arrangement management system has a function that checks that the value of a service level required by data is included in the range of a service level SLA guaranteed by the storage where the data is stored and, based on the checking result, determines the data arrangement.

The data arrangement management system according to the present invention has a function that saves service level information on data and storage areas.

The data arrangement management system according to the present invention has a function that generates an HSM policy for migrating data so that SLO of data is satisfied by SLA of the storage area where the data is stored.

The data arrangement management system according to the present invention has a function that selects only new data, data whose required service object is changed, and data whose service level object was not satisfied in the immediately preceding data arrangement processing to check whether the SLA of the storage area where the selected is stored satisfies the SLO.

The data arrangement management system according to the present invention has a function that, even if other data cannot be migrated after data was migrated previously to achieve the required service object, does not cancel the previous migration operation but carries over the solution of the problem that the service level object of data, which cannot be migrated, is not satisfied to the next and subsequent operations.

The data arrangement management system according to the present invention has a function that, if the free area size of a storage area becomes equal to or smaller than a predetermined value after data is migrated to satisfy the SLO, migrates the stored data to another storage area within a range, in which the service level is satisfied, for reserving the free area size.

The meritorious effects of the present invention are summarized as follows.

The present invention makes possible the practical operation of ILM for which only the concept is discussed but which is not yet implemented in an actual system.

The present invention performs the following for recorded data:
Check whether the data should be migrated from the current storage area to another storage area;
Determine a migration destination storage area that satisfies the SLO of the data.

The present invention can provide a function that saves the settings of, and the changes in, service levels of entire pieces of data recorded in entire storage areas as well as service levels of entire storage areas where data is stored, under the management of the data arrangement management system and that retrieves the information whenever it is required to check whether the required service object of data is satisfied.

The present invention allows the user to use the data arrangement management system to send information about data to be migrated and its migration destination to the HSM system to actually move the data using the data migration means provided by HSM.

The present invention reduces the number of data pieces to be searched for and, as a result, reduces the processing time to such an extent it is much shorter than that required when the service level objects of all stored data are checked as to whether they are satisfied.

The present invention eliminates the need to select storage locations of the same data two or more times, thus reducing the number of times the data storage locations are selected and, as a result, reducing the processing time.

The present invention determines the arrangement of data so that required service object is satisfied. Therefore, the present invention suppresses the generation of an storage area having an insufficient free area size and, in the next and subsequent processing in the same system, prevents a condition in which data cannot be migrated to satisfy the required service object due to an insufficient free area size.

The present invention can determine the arrangement of data that satisfies the SLOs of entire pieces of data in a processing time that does not depend on the total number of data pieces. The reason is that the present invention does not change the locations of entire pieces of data so that the SLOs are satisfied for implementing ILM but selectively changes the location of only the following data:
Data whose SLO is not satisfied; and
Created data.

In addition, with the technique according to the present invention, a combination of all managed data locations is not calculated but the location of each piece of data whose location is changed is independently determined and, even if the determined location influences the location of other data, does not change the location of data that is once determined. Therefore, the number of times the SLO is evaluated is reduced from
The power of (Total number of storage areas) with (Total number of data pieces) as an exponent to
(Number of data pieces whose SLO is not satisfied or which is created)×(Total number of storage areas)

According to the present invention, the calculation time especially when the number of data pieces is increased.

Furthermore, if there is data whose SLO is not satisfied in the arrangement processing executed immediately before, the solution is carried over to the next and the following processing. Therefore, in the present invention, take long in each operation of processing and reduces the processing time of each operation.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing the general system configuration in one example of the present invention.

FIG. 2 is a diagram showing the configuration of an ILM device in one example of the present invention.

FIG. 3 is a block diagram showing the detailed configuration of an ILM execution unit in FIG. 2.

FIG. 4 is a block diagram showing the configuration of an ILM device control unit in FIG. 2.

FIG. 5 is a flowchart showing a processing procedure for ILM processing executed by the ILM device in one example of the present invention.

FIG. 6 is a flowchart showing a detailed processing procedure in step S1 in FIG. 5.

FIG. 7 is a flowchart showing a detailed processing procedure in step S2 in FIG. 5.

FIG. 8 is a diagram showing the configuration of an ILM device control unit in a second example of the present invention.

### PREFERRED MODES OF THE INVENTION

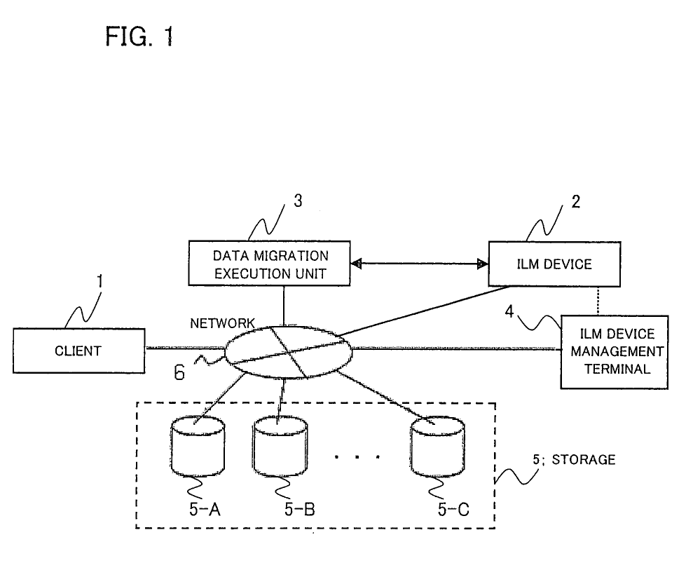

FIG. 1 is a diagram showing the configuration of a system in one example of the present invention. In the description below, one storage area may be one physical storage device or a logical storage unit (for example, a logical volume, a directory tree, or a partition). For example, when multiple physical storage devices are managed by the logical volume manager (LVM) as one file system, one storage area includes multiple storage devices. Alternatively, an area (partition) generated by dividing a storage device may be made correspond to one storage area.

The system generally comprises one or more clients 1 that access data, storage 5 (file server, NAS (Network Attached Storage), etc.) that have multiple storage areas 5-A, 5-B, . . . , 5-C in which data is stored, an ILM device 2 that manages the data arrangement of the storage 5 by means of ILM (Information Lifecycle Management), a data migration execution unit 3 that migrates data among storage areas responsive to an instruction from the ILM device 2, an ILM device management terminal 4 used to manage or change the settings of the ILM device 2, and a network 6. Although the ILM device management terminal 4 is connected to the ILM device 2 via the network 6 in FIG. 1, the present invention is not limited to this configuration but the ILM device management terminal 4 may also be connected directly to the ILM device 2.

According to the present invention, the ILM device 2 stores and manages a service level (Service Level Agreement; hereinafter termed SLA) that is a service level guaranteed to data by a storage area, checks whether or not the SLA of a storage area, where data is stored, satisfies the required Service Level Object (hereinafter termed SLO) assigned to the data, and controls the data arrangement processing so that the management requirements for storing data in a storage area having an SLA, which satisfies the SLO, are satisfied. If the SLA of a storage area where data is stored does not satisfies the SLO of the data, the ILM device 2 selects a storage area, which satisfies the SLO of the data, from the multiple storage areas 5-A, 5-B, . . . , 5-C and stores the data in the selected storage area.

In one example of the present invention, if one storage area contains data whose SLO may not be satisfied, the ILM device 2 checks whether or not the SLO is satisfied in the storage area where the data is stored, based on the SLO of the data and the SLA of the storage area. If the checking result indicates that the SLO is not satisfied, the ILM device 2 determines another storage area having an SLA corresponding to the SLO of the data and stores the data in the determined storage area. In this case, it is also possible to cause the data migration execution unit 3, which migrates data between storage areas, to move the data from the storage area described above to the determined another storage area.

In one example of the present invention, if the data migration execution unit 3 migrates data between storage areas and, as a result, other data cannot be migrated, the ILM device 2 does not cancel the migration of the data. Instead, the ILM device 2 carries over the solution of the problem that the SLO of the other data, which cannot be migrated, is not satisfied to the next and the subsequent data arrangement processing (ILM processing).

In one example of the present invention, if the location of data is changed to satisfy the SLO and, as a result, the free area size becomes equal to or lower than a predetermined value in a storage area, the ILM device 2 migrates data from the storage area to another storage area within a range, in which the SLO is satisfied, to reserve a free area.

In one example of the present invention, the ILM device 2 checks whether or not the SLO is within a range of the SLA guaranteed by the storage area, in which data is stored, for at least one of the following data: data created after the previous data arrangement processing (ILM processing), data whose SLO value requested by the data is changed, data stored in a storage area whose SLA is changed, and data whose SLO was not satisfied in the previous data arrangement processing.

In one example of the present invention, if there are multiple storage areas having an SLA satisfying the SLO of data, it is possible that the ILM device 2 calculates a score based on the difference in value between the SLA of the storage area and the SLO of the data for selecting a minimum-score storage area as the migration destination.

For example,

Score=Σ|(SLA parameter of storage area where data is stored)−(SLO parameter) (1)

If the SLA of a storage area where data is stored has four attributes, SLA=(p₁, p₂, p₃, p₄), and the SLO of data is SLO=(q₁, q₂, q₃, q₄), then the scores is given by the following expression.

Score==Σᵢ₌₁⁴|pᵢ−qᵢ|

If there are multiple candidates for the migration destination storage area, the minimum-score (that is, minimum distance) storage area is selected. The score is not limited by the distance but may also be calculated by the following expression.

$$Score = \sqrt{{\sum }_{i = 1}^{4} {( {p}_{i} - {q}_{i} )}^{2}}$$

Although not limited thereto, the indexes such as encryption, backup characteristics, redundancy, and performance are used as SLO attribute parameters.

It is also possible that the SLO has two types of values, that is, a target value that is a parameter required to be satisfied as much as possible and a parameter must value (MUST attribute) that must always be satisfied, to allow the ILM device 2 to select a storage area satisfying the parameter must value. For example, if the SLO of data is SLO=(q₁, q₂, q₃, q₄) and the attribute q₁ of the attribute of the first term is the MUST attribute, it is assumed that p₁ in SLA=(p₁, p₂, p₃, p₄) satisfies qᵢ.

It is also possible that the SLO has two types of parameter values, that is, an upper limit value and/or a lower limit value, which can be assigned to a parameter, to allow the ILM device 2 to process the upper limit value and the lower limit value separately in the processing. For example, if the parameter value of 1 corresponds to WORM (Write Once Read Many) for the WORM attribute of the SLO parameter and if a storage area having an SLA where the WORM attribute parameter value is 0 or larger is selected for data having an SLO where WORM attribute parameter value is 0 and the data is stored in that storage area, an inconvenient condition occurs in which the data can be read but cannot be written. In this case, the upper limit value and the lower limit value of the SLO parameter are separated. The lower limit value of the WORM attribute parameter value is set to 1 and is separated from the WORM attribute parameter value of 0. Data having the WORM attribute parameter value of 0 is not stored in a storage area having the WORM attribute parameter value of 1 or larger.

It is also possible that, if the time required for the data arrangement processing (ILM processing) exceeds a predetermined time, the ILM device 2 suspends the processing at that point in time by completing the processing prematurely, migrates the data for which the processing has been completed up to that time, and carries over the processing of the data, which remains unprocessed because of the suspension, to the next and subsequent data arrangement processing.

It is possible to inhibit the ILM device 2 from migrating data, which has been migrated to another storage area by the data migration execution unit 3, to some other storage area during a predetermined period. When the present invention is applied to an enterprise system where the execution cycle of the data arrangement processing by the ILM device 2 is once a day (for example, when the business ends) and the predetermined period described above (during which data cannot be migrated) is two or three days, the data migrated to another storage area in the immediately preceding ILM processing is inhibited from being migrated, though not limited thereto, to some other storage area in the current or the current and the next ILM processing. Inhibiting the data migration during a predetermined period in this way prevents data from being migrated frequently when an abnormality occurs during the ILM processing. It is of course possible that the data migration inhibition period may be set freely in accordance with the system.

In addition, it is also possible that the ILM device 2 checks data in a predetermined storage area whether the data can be migrated to an area having an SLA better than that of the current area and, if so, migrates the data to that area. That is, the ILM device 2 may manage the data arrangement based on an SLA on an area basis in a storage area.

It is also possible that the ILM device 2 checks entire pieces of data in a predetermined storage area to search for an area, which has an SLA satisfying the SLO, from an area not included in the predetermined storage area.

When the storage 5 including multiple storage areas 5-A, 5-B, . . . , and 5-C is installed for use in HSM (Hierarchical Storage Management) in one example of the present invention, the data migration means provided in the HSM implementation environment is used as the data migration execution unit 3.

In the present invention, a policy for migrating data may be variably set and generated so that the SLO of data is satisfied by the SLA of a storage area where the data is stored.

Although the ILM device 2 is connected, not via the network 6, but directly to the data migration execution unit 3 in the system configuration shown FIG. 1, the ILM device 2 may also send and receive requests and responses of instruction commands to and from the data migration execution unit 3 via the network 6.

Although the ILM device 2 is configured as a server of the client 1, the present invention is not limited to such configuration. For example, the ILM device 2 and the data migration execution unit 3 may be integrated into one module that is installed in an intermediate device (not shown) between the storage 5 and the network 6.

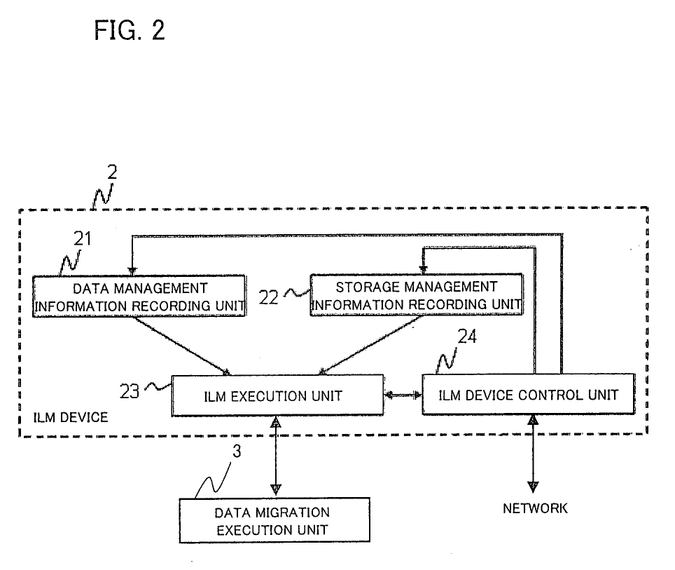

FIG. 2 is a diagram showing an example of the configuration of the ILM device 2 in FIG. 1. Referring to FIG. 2, the ILM device 2 comprises a data management information recording unit 21, a storage management information recording unit 22, an ILM execution unit 23, and an ILM device control unit 24.

The data management information recording unit 21 stores the following information on the data stored in the storage 5:
Value of SLO that is the requested service object
Data size
Storage area in which data is stored

### In addition, the data management information recording unit 21 stores the initial value of the SLO to be assigned to created data.

The storage management information recording unit 22 stores the following information on each storage area that is managed:
Value of the SLA indicating the service level guaranteed to data that is stored
Total size of the storage area
Free area size in the storage area
Threshold used to determine that the free area size of the storage area is insufficient

The ILM execution unit 23, which is started by an operation instruction issued from the ILM device control unit 24, calculates a arrangement that satisfies the SLO for implementing the ILM-based data management and sends the calculated result to the data migration execution unit 3.

The ILM device control unit 24
Controls the operation of the whole ILM device 2; and
Performs interface processing with ILM device management terminal 4

In addition, the ILM device control unit 24
Collects information on the free area size in the storage areas from the storage 5 via the network 6; and
Monitors access from the client 1 to the storage 5 on the network 6 and generates, collects, and analyzes an access log on the generation, deletion, and update of data in the storage 5

It is of course possible that the ILM execution unit 23 and the ILM device control unit 24 are implemented by a program running on the computer constituting the ILM device 2.

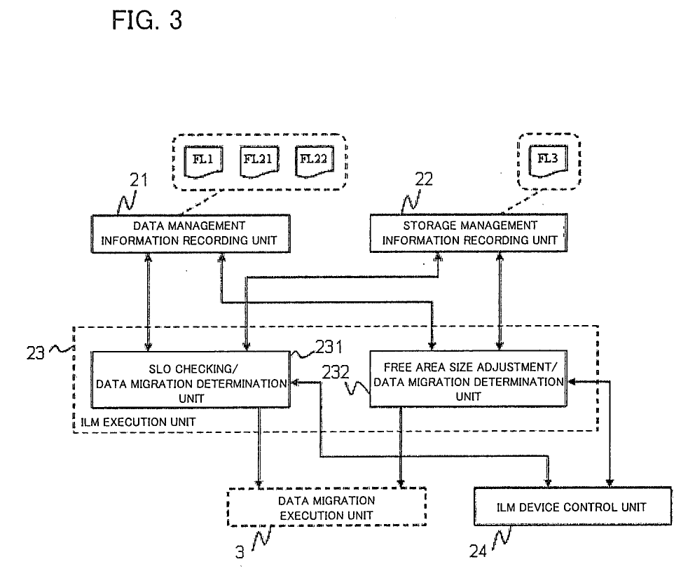

Next, the following describes the configuration of the ILM execution unit 23 in FIG. 2 more in detail. FIG. 3 is a diagram showing an example of the detailed configuration of the ILM execution unit 23 shown in FIG. 2. Referring to FIG. 3, the ILM execution unit 23 comprises an SLO checking/data migration determination unit 231 and a free area size adjustment/data migration determination unit 232. It is of course possible that the SLO checking/data migration determination unit 231 and the free area size adjustment/data migration determination unit 232 are implemented by a computer program (module) that implements the function of the ILM execution unit 23.

During the operation, the ILM execution unit 23 uses the flags and information, described below, that are stored in the data management information recording unit 21 and the storage management information recording unit 22.

The data management information recording unit 21 stores flags FL1 that are set when there is a possibility that the SLO of data is not satisfied, one flag for each piece of data stored in the storage 5.

Data indicated by this flag that there is a possibility that the SLO is not satisfied is one of the following:
Data created after the ILM device 2 performed data arrangement processing (ILM processing) last
Data whose SLO parameter is changed and
Data whose SLO was not satisfied when the ILM device 2 was run to execute the ILM processing

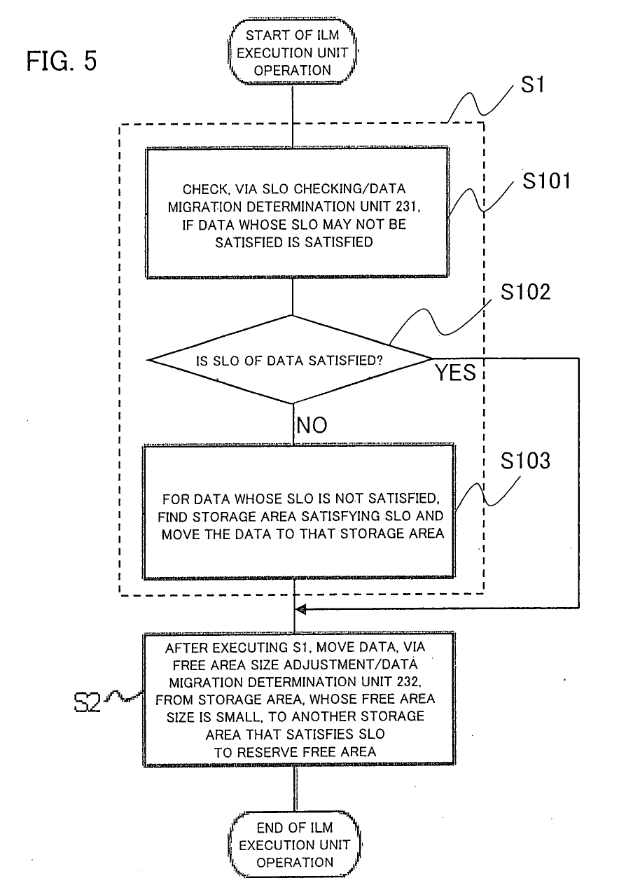

The data management information recording unit 21 also stores information FL21 and FL22, one set of FL21 and FL22 for each piece of data stored in the storage 5. The information FL21 and FL22 indicate when the SLO of the data was last checked by the ILM device 2, respectively, in processing steps S1 and S2 of the ILM device 2 shown in FIG. 5 that will be referenced in the description below.

On the other hand, the storage management information recording unit 22 stores flags FL3, one for each storage area included in the storage 5. The flag FL3 is set when the SLA parameter of a storage area is changed after the ILM device 2 performed the ILM processing last.

The SLO checking/data migration determination unit 231 checks if each managed storage area included in the storage 5 satisfies the SLO of the data, determines the arrangement and the migration destination storage area best suited to the data based on the checking and, if the data must be migrated, sends a data migration instruction to the data migration execution unit 3.

The SLO checking/data migration determination unit 231 sends an operation start/end notification to the ILM device control unit 24. Conversely, when an operation interrupt instruction is received from the ILM device control unit 24, the SLO checking/data migration determination unit 231 interrupts the processing.

In addition, when the possibility that the SLO of data is not satisfied is gone, the SLO checking/data migration determination unit 231 clears the flag FL1. As described above, this FL1 is a flag stored in the data management information recording unit 21 to indicate that there is a possibility that the SLO of the data is not satisfied.

When data is processed in processing step S1 of the ILM device 2 shown in FIG. 5 and processing is performed to find the migration destination of the data, the SLO checking/data migration determination unit 231 updates the information FL21 to indicate that the data was processed in step S1 of the current ILM processing executed by the ILM device 2. As described above, the information FL21 is stored in the data management information recording unit 21 to indicate when the SLO of the data was checked last in step S1.

If the flag FL3 is set to indicate that the SLA of the storage 5 is changed after the ILM device 2 performed the ILM processing last, the SLO checking/data migration determination unit 231 clears the flag FL3 when the processing is terminated.

If the free area size of a storage area in the storage 5 is insufficient, the free area size adjustment/data migration determination unit 232 checks whether the SLO of the data is satisfied if the data stored in that storage area is migrated to another storage area.

If the checking result indicates that the SLO of the data is satisfied and if the free area size of the data migration destination is not insufficient after the migration and, therefore, the data can be migrated to that another storage area, the free area size adjustment/data migration determination unit 232 instructs the data migration execution unit 3 to move the data to that another storage to which the data can be migrated.

The free area size adjustment/data migration determination unit 232 sends an operation start/end notification to the ILM device control unit 24. Conversely, when an operation interrupt instruction is received from the ILM device control unit 24, the free area size adjustment/data migration determination unit 232 interrupts the processing.

In addition, when the possibility that the SLO of data is not satisfied is gone, the free area size adjustment/data migration determination unit 232 clears the flag FL1 that is stored in the data management information recording unit 21. As described above, the FL1 is a flag indicating that there is a possibility that the SLO of the data is not satisfied.

Furthermore, when data is processed in processing step S2 (see FIG. 5) and processing is performed to find the migration destination of the data, the free-space size adjustment/data migration determination unit 232 updates the information FL22 to indicate that the data was processed in step S2 (see FIG. 5) of the current ILM processing executed by the ILM device. As described above, the information FL22 is stored in the data management information recording unit 21 to indicate when the SLO of the data was checked and processed last in step S2 (see FIG. 5).

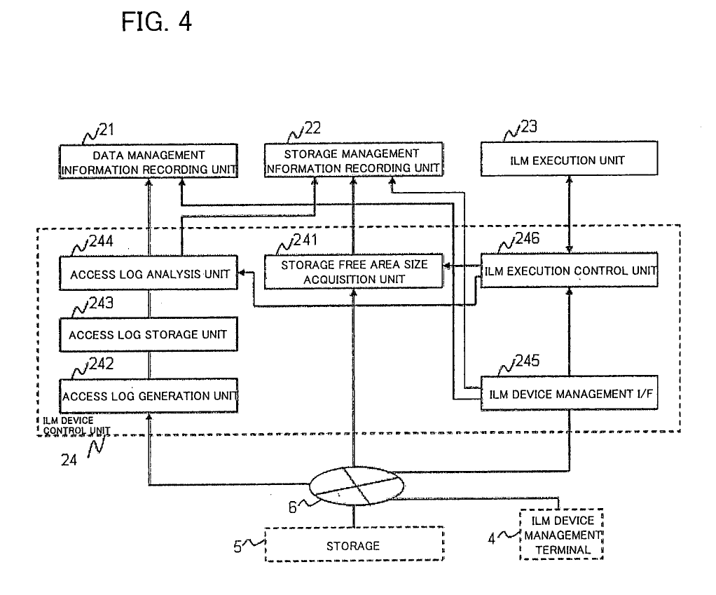

Next, the following describes the detailed configuration of the ILM device control unit 24 in FIG. 2. FIG. 4 shows an example of the detailed configuration of the ILM device control unit 24 in FIG. 2. Referring to FIG. 4, the ILM device control unit 24 comprises a storage free area size acquisition unit 241, an access log generation unit 242, an access log storage unit 243, an access log analysis unit 244, an ILM device management I/F 245, and an ILM execution control unit 246. It is of course possible that those components are implemented by computer programs (modules) that execute the function of the ILM device control unit 24 when the ILM device 2 is implemented by computer programs.

The storage free area size acquisition unit 241 obtains the free area sizes of the storage areas from the storage 5 via the network 6 and stores the values in the storage management information recording unit 22.

The storage free area size acquisition unit 241 suspends and resumes the storage of information into the storage management information recording unit 22 responsive to an instruction from the ILM execution control unit 246.

The access log generation unit 242 monitors the network 6 to generate the access history information on access from the client 1 to the data stored in the storage 5. The information on the generated access log and the storage area load is stored in the access log storage unit 243.

The access log storage unit 243 stores the access log, generated by the access log generation unit 242 in the ILM device control unit 24, and supplies the stored access log to the access log analysis unit 244 responsive to a request issued from that unit.

The access log analysis unit 244 reads the access log on the data, which is stored in the storage 5 of the client 1, from the access log storage unit 243 and analyzes the access log. The access log analysis unit 244 detects the creation of data in, and the deletion of data from, the storage 5 or detects a change in the size of data stored in the storage 5, and stores the detection result in the data management information recording unit 21 and the storage management information recording unit 22. In addition, responsive to an instruction from the ILM execution control unit 246, the access log analysis unit 244 suspends and resumes of storage of information into the data management information recording unit 21.

The ILM device management I/F 245 processes:
An instruction from the ILM device management terminal 4 to start and end ILM processing; and
A request to set the ILM device, the SLO of data, and the SLA of a storage area

When the SLO of data stored in the storage 5 is changed, the flag FL1 is set because there is a possibility that the SLO is not satisfied when the SLO is changed.

When the SLA of a storage area included in the storage 5 is changed, the flag FL3, which indicates that the SLA of the storage area is changed, is set.

The ILM execution control unit 246 controls the operation of the ILM execution unit 23 to manage the operation of the whole ILM device 2.

The ILM execution control unit 246 receives an instruction from the ILM device management I/F 245 to start or stop the operation of the ILM execution unit 23.

FIG. 5 is a flowchart showing the operation procedure of one example of the present invention. The following describes the operation of this example with reference to FIG. 5 and FIGS. 1-4.

According to the present invention, the ILM device control unit 24 of the ILM device 2 constantly performs the following operation.

The access log generation unit 242 included in the ILM device control unit 24 monitors the network 6 to detect access from the client 1 to the data in the storage 5 and generates an access log.

The access log generated by the access log generation unit 242 is recorded in the access log storage unit 243, and the access log analysis unit 244 analyzes the access log.

From the access log, the access log analysis unit 244 extracts information on
Detection of newly generated data;
Change in data size; and
Deletion of data
   that occur in the storage 5 after the previous operation of the ILM device 2, and constantly reflects the extracted information in the data management information recording unit 21.

For newly created data, the following is set in the data management information recording unit 21.
Data size and standard SLO value; and
Flag FL1 to indicate that there is a possibility that the SLO is not satisfied.

The storage free area size acquisition unit 241 acquires a change in the size of the free area of the storage 5 and reflects the acquired information in the storage management information recording unit 22.

In addition, the ILM device management I/F 245 continuously accepts an instruction to change the setting and an instruction to operate the ILM processing from the ILM device management terminal 4.

A setting change instruction accepted by the ILM device management I/F 245 is reflected in the data management information recording unit 21 and the storage management information recording unit 22, and an ILM processing operation instruction is passed to the ILM execution control unit 246.

When the SLO of data is changed, the flag FL1, stored in the data management information recording unit 21, is set to indicate that there is a possibility that the SLO of the data is changed after the ILM device 2 performed the ILM processing last. When the SLA of a storage area is changed, the flag FL3, stored in the storage management information recording unit 22, is set to indicate that the SLA of the storage area is changed after the ILM device 2 performed the ILM processing last.

In addition, the ILM device management I/F 245 accepts the information (initial value of the SLO, the threshold for checking whether or not the free area size is insufficient) about newly created data from the ILM device management terminal 4, and reflects those values in the data management information recording unit 21 and the storage management information recording unit 22.

The ILM device 2 starts the ILM processing when the ILM device 2 receives an ILM processing start instruction from the ILM device management terminal 4.

More specifically, the ILM device management I/F 245 receives the ILM processing start instruction and sends the received ILM processing start instruction to the ILM execution control unit 246.

The ILM execution control unit 246 invokes the SLO checking/data migration determination unit 231 and the free area size adjustment/data migration determination unit 232 of the ILM execution unit 23 according to the operation sequence described below. At the same time, the ILM execution control unit 246 sends an instruction to the storage free area size acquisition unit 241 and the access log analysis unit 244 to stop the update of the information in the storage management information recording unit 22 and the data management information recording unit 21.

Next, the ILM execution control unit 246 invokes the SLO checking/data migration determination unit 231 to perform the following operation.

The ILM device 2 checks data created after the previous ILM processing, data whose SLO is changed, or data stored in a storage area whose SLA is changed, whether the SLO is satisfied in the storage area in which the data is stored. To do so, the SLO checking/data migration determination unit 231, included in the ILM execution unit 23, reads the SLO of the data from the data management information recording unit 21, and the SLA of the storage area, in which the data is currently stored, from the storage management information recording unit 22, and checks if the SLA satisfies the SLO (step S101).

In addition, for data whose SLO is not satisfied in the checking in the immediately preceding step S101 (NO in step S102), the SLO checking/data migration determination unit 231 compares the SLO with the SLA value (indicating the guaranteed service level) of all storage areas in the storage 5, and selects a storage area, whose SLA satisfies the SLO of the data, as the data migration destination. When the data migration destination is determined, the SLO checking/data migration determination unit 231 instructs the data migration execution unit 3 to move the data. In response to the instruction, the data migration execution unit 3 migrates the data to the storage area selected as the migration destination (S103).

After executing the processing steps S101 to S103, the SLO checking/data migration determination unit 231 terminates the operation.

Note that the data migration between storage areas as a result of the execution of the steps to the step S103 may create the possibility of an insufficient free area size in the storage area.

After the operation of the SLO checking/data migration determination unit 231 described above is terminated, the ILM execution control unit 246 starts the free area size adjustment/data migration determination unit 232 and executes the following processing steps to solve the problem of the insufficient free area size in the storage areas.

The ILM device 2 causes the free area size adjustment/data migration determination unit 232, included in the ILM execution unit 23, to acquire from the storage management information recording unit 22 the free area size in each storage area included in the storage 5 and the free area size threshold used to determine that the free area size in the storage area is insufficient.

For each storage area, the free area size adjustment/data migration determination unit 232 compares the free area size threshold of the storage area, used to determine if the free area size is insufficient, with the actual free area size and, if the comparison result indicates that the free area size is insufficient, executes the following processing steps to solve the problem of the insufficient free area size of the storage area.

To solve the problem of the insufficient free area size in each storage area, the free area size adjustment/data migration determination unit 232, included in the ILM execution unit 23, reads the data stored in a storage area whose free area size is insufficient, as well as the SLO of the data, from the data management information recording unit 21. The free area size adjustment/data migration determination unit 232 also reads the SLA of each storage area included in the storage 5 and its current free area size, as well as the threshold used to determine that the free area size of the storage area is insufficient, from the storage management information recording unit 22.

If, other than the storage area in which the data is currently stored, there is a storage area which satisfies the SLO of the data and if the free area size of that area is not determined insufficient even after the data is migrated thereto, the free area size adjustment/data migration determination unit 232 sends an instruction to the data migration execution unit 3 to move the data to that storage area (step S2).

After step S2 described above is terminated, the operation of the free area size adjustment/data migration determination unit 232 is terminated.

When the ILM operation of the ILM device is terminated, the ILM execution control unit 246 instructs the storage free area size acquisition unit 241 and the access log analysis unit 244 to restart the updating of information in the storage management information recording unit 22 and the data management information recording unit 21.

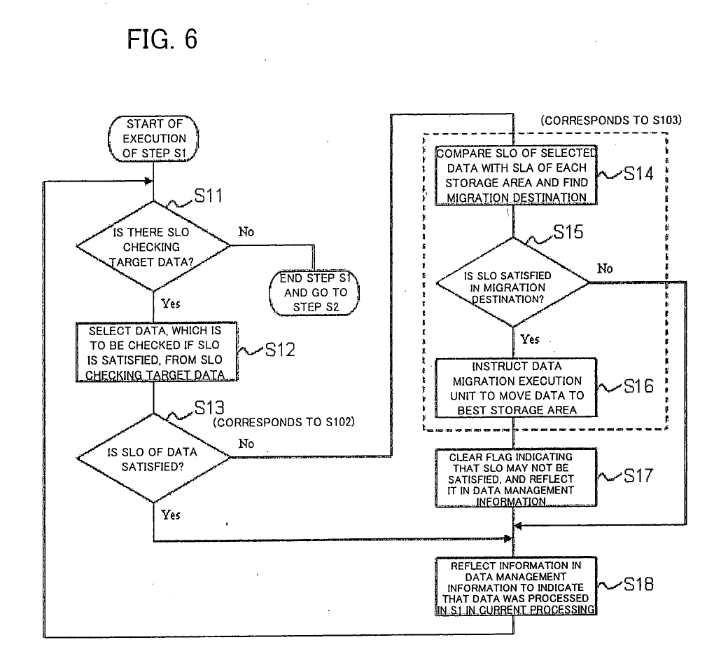

FIG. 6 is a diagram showing the detailed processing of step S1 in FIG. 5. The following describes the detailed processing procedure of step S1, composed of steps S101 to S103 in FIG. 5, with reference to FIG. 6.

The ILM execution unit 23 included in the ILM device 2 checks if the storage 5 still stores data whose SLO may not be satisfied.

Data whose SLO may not be satisfied is one of the following:
Data created after the ILM device 2 performed the ILM processing last;
Data whose SLO is changed after the ILM device 2 performed the ILM processing last;
Data stored in a storage area whose SLA is changed after the ILM device 2 performed ILM processing last; and
Data whose SLO was not satisfied in the ILM processing performed immediately before.

The SLO checking/data migration determination unit 231, included in the ILM execution unit 23, references the data management information recording unit 21 to find a set of data whose SLO may not be satisfied (that is, a set of data whose flag FL1 is set). In the subsequent processing, this set of data is treated as checking target data for which the check is made if the SLO is satisfied.

The SLO checking/data migration determination unit 231 references the storage management information recording unit 22. If there is a storage area whose SLA is changed (that is, a storage area whose flag FL3 is set), the SLO checking/data migration determination unit 231 references the data management information recording unit 21 and adds the data, stored in the storage area whose SLA is changed, to the set of checking target data for which the check is made in the subsequent processing to see if the SLO is satisfied.

If there is no SLO checking target data, there is no data
Which is stored in the storage 5 and whose SLO may not be satisfied; and
For which no check is made for the SLO in the current ILM processing.

### If there is no data that satisfies the condition described above, the processing in step S1 in FIG. 5 is terminated and, after that, control is passed to the processing of step S2.

At this time, if the flag FL3 in the storage management information recording unit 22 is set to indicate that the SLA of a storage area is changed after the ILM device 2 performed the ILM processing last, the flag is cleared.

On the other hand, if there is data whose SLO may not be satisfied and, in the current ILM processing, the check is not yet made for some data whether the SLO is satisfied, that is, if there is some data for which the check is to be made for the SLO (Yes in step S11 in FIG. 6), the processing in step S12 and the following steps in FIG. 6 are executed.

The SLO checking/data migration determination unit 231, included in the ILM execution unit 23, remigrates data, whose SLO was already checked in the current ILM processing, from the set of data selected as described above for SLO checking and, from the remaining data, extracts data for which the check is to be actually made. That is, the SLO checking/data migration determination unit 231 references the information FL21, stored in the data management information recording unit 21 to indicate when data included in the set was processed in step S1, and selects data only from data, which is not yet processed in the current ILM processing, for processing in the subsequent ILM processing.

In the subsequent processing steps, the SLO checking/data migration determination unit 231 checks the data selected in this step (step S12 in FIG. 6).

The SLO checking/data migration determination unit 231 reads the SLO and the size of the data, selected in step S12 in FIG. 6, from the data management information recording unit 21.

The SLO checking/data migration determination unit 231 also reads the SLA of the storage area, in which the selected data is stored, from the storage management information recording unit 22.

Based on the information that has been read, the SLO checking/data migration determination unit 231 checks if the SLO of the data is satisfied, that is, if the SLO is within the value of the SLA.

If the checking result indicates that the SLO of the data is satisfied, there is no need to move the data from the storage area in which the data is currently stored. Therefore, the SLO checking/data migration determination unit 231 skips steps S14 to S17 (see FIG. 6), in which the data migration destination is searched for and the data is actually migrated, and executes step S18 that will be described later.

If the SLO of the checked data is not satisfied (No in step S13 in FIG. 6), the SLO checking/data migration determination unit 231 executes step S14 and the following steps to move the data so that the SLO of the data is satisfied.

Step S13 in FIG. 6 corresponds to step S102 in FIG. 5.

In step S14 in FIG. 6, the SLO checking/data migration determination unit 231 reads the SLA of each storage area, included in the storage 5, from the storage management information recording unit 22.

The SLO checking/data migration determination unit 231 compares the SLO of the checking target data, selected in step S12 in FIG. 6, with the SLA of each storage area and searches for a storage area that satisfies the SLO of the checking target data. At this time, another requirement for the storage area of the migration destination is that the size of the checking target data is equal to or smaller than the size of the free area in a storage area. If there is no storage area that satisfies the migration destination requirements, that is, if there is no storage area that satisfies the SLO of the checking target data and has a free area whose size is equal to or larger than the checking target data size, the migration destination of the checking target data cannot be determined.

If the migration destination of the checking target data is determined in step S14 in FIG. 6, the SLO checking/data migration determination unit 231 executes the procedure step S16 and the following steps, which will be described later, to move the data to the migration destination storage area determined in S14.

On the other hand, if a migration destination storage area satisfying the SLO is not determined in step S14 in FIG. 6 (No in step S15 in FIG. 6), the data is not migrated. In this case, the SLO checking/data migration determination unit 231 does not execute steps S16 and S17 in FIG. 6, which are processing steps for data migration processing, but passes control to step S18.

The SLO checking/data migration determination unit 231 issues an instruction to the data migration execution unit 3 and instructs it to move the checking target data, selected in step S12 in FIG. 6, to the migration destination storage area of the checking target data determined in step S14 in FIG. 6. In this way, the SLO checking/data migration determination unit 231 migrates the checking target data to the storage area determined in step S14 that is the new storage area in which the data is stored.

At the same time, the SLO checking/data migration determination unit 231 calculates the free area sizes of the migration source and destination storage areas after the migration from the size of the checking target data and stores the calculated sizes in the storage management information recording unit 22 (step S16 in FIG. 6).

The operation performed by steps S14, S15, and S16 in FIG. 6 corresponds to step S103 in FIG. 5.

The possibility that the SLO is not satisfied is gone because the checking target data was migrated to another storage area so that the SLO is satisfied. So, the SLO checking/data migration determination unit 231 clears the flag FL1 in the data management information recording unit 21 stored therein for the migrated data (step S17).

The SLO checking/data migration determination unit 231 reflects in the information FL21, stored in the data management information recording unit 21, that the SLO of the data processed in step S1 was checked to see if it is satisfied in step S1 in the current processing so that the FL21 indicates that the SLO of the data was already checked in the current ILM processing.

The processing for the checking target data selected in step S12 is terminated and control is passed back to step S11 to check another piece of data to see if the SLO is satisfied and, if necessary, the data is migrated to another storage area where the SLO is satisfied (step S18).

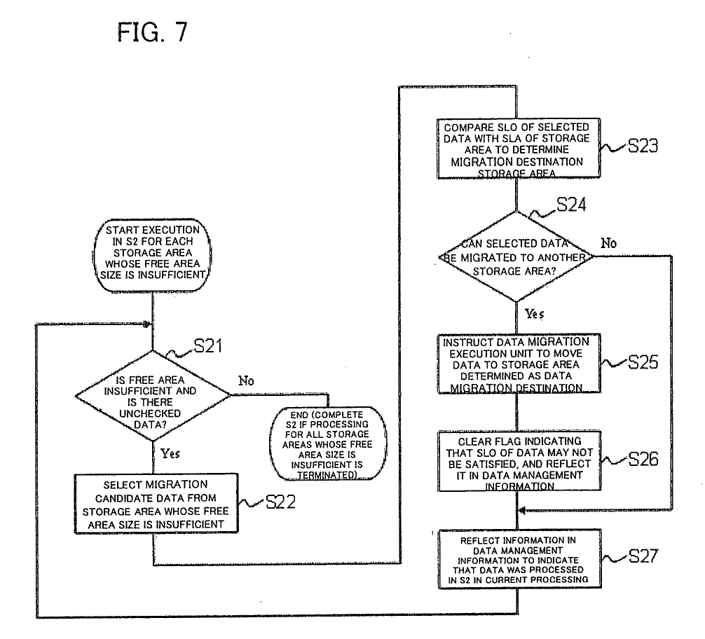

FIG. 7 is a flowchart showing the detailed processing steps of step S2 in FIG. 5. The processing steps shown in FIG. 7 are executed individually for each storage area included in the storage 5. The following describes the processing steps performed for one storage area included in the storage 5.

The ILM execution unit 23 included in the ILM device 2 checks if the free area size in one particular storage area is insufficient. To do so, the free area size adjustment/data migration determination unit 232 included in the ILM execution unit 23 acquires the threshold value for determining if the free area of the particular storage area is insufficient and the current free area size from the storage management information recording unit 22.

The free area size adjustment/data migration determination unit 232 compares the current free area size with the free area size threshold and, if the former is larger than the latter, that is, if the free area size of the particular storage area is not insufficient (No in step S21), there is no need for reserving a free area. In this case, step S2 of the ILM processing for the particular storage area is terminated.

Conversely, if the free area size is insufficient and if there is data which is stored in the particular storage area and for which the check is not yet made as to whether the SLO will be satisfied after the data is migrated to another storage area during the current ILM processing (Yes in step S21), the free area size adjustment/data migration determination unit 232 performs the following processing in step S22 to solve the problem of the insufficient free area size in the particular storage area. That is, to reserve a free area in the particular storage area, the free area size adjustment/data migration determination unit 232 selects data from among data, which is stored in the particular storage area and for which the check is not yet made as to whether the data can be migrated to another storage area, data whose SLO will be satisfied even after the data is migrated to that another storage area.

More specifically, the free area size adjustment/data migration determination unit 232 included in the ILM execution unit 23 references the information FL22 stored in the data management information recording unit 21 for each piece of data stored in the particular storage area and extracts a set of data that is not yet checked in step S2 of the current ILM processing as to whether the data can be migrated to another storage area.

From the set, the free area size adjustment/data migration determination unit 232 selects data, which will be actually checked if the SLO will be satisfied after the data is migrated to other storage areas, as a data candidate that will be migrated to another storage area in the following processing steps.

In the following steps, the processing is performed for the data selected in the processing step described above. The above processing is performed in step S22.

The free area size adjustment/data migration determination unit 232 acquires the SLO and size of data, selected in step S22, from the data management information recording unit 21, and acquires the free area size of each storage area included in the storage 5, the threshold used to determine that the free area size of each storage area is insufficient, and the SLA of each storage area from the storage management information recording unit 22.

Using the acquired information, the free area size adjustment/data migration determination unit 232 searches for other storage areas to which the data selected in step S22 can be migrated.

Whether or not a storage area is an area to which the checking target data can be migrated is determined by checking if the SLO of the checking target data is satisfied in the migration destination storage area and if the free area size of the migration destination storage area will not become insufficient when the data is migrated to that storage area.

If two or more storage areas to which checking target data can be migrated are found (Yes in step S24), the free area size adjustment/data migration determination unit 232 determines one of the storage areas as the migration destination (steps S25 and S26).

Conversely, if a storage area to which the checking target data can be migrated is not found (No in step S24), there is no storage area to which the data is migrated and the data is not migrated. That is, if the data cannot be migrated, that is, if no migration destination storage area is found in step S23, the free area size adjustment/data migration determination unit 232 does not execute processing steps S25 and S26, in which the checking target data is migrated, but executes the processing in step S27 that will be described later.

If the checking target data can be migrated from the particular storage area, that is, if the migration destination storage area is determined in step S23, the free area size adjustment/data migration determination unit 232 actually migrates checking target data in step S25 according to the following processing steps.

The free area size adjustment/data migration determination unit 232 sends an instruction, which migrates the data selected in step S22 to the migration destination storage area determined in step S23, to the data migration execution unit 3 to move the data.

At the same time, the free area size adjustment/data migration determination unit 232 calculates the free area sizes of the migration source storage area and the migration destination storage area from the size of the migrated data after the completion of the data migration and stores the calculated result in the storage management information recording unit 22. The processing described above is performed in step S25.

The data selected in step S22 is migrated to another storage area where the SLO is satisfied, without the problem of an insufficient storage area size. Thus, this method invariably satisfies the SLO.

If the flag FL1 stored in the data management information recording unit 21 is set to indicate the possibility that the SLO of the migrated data is not satisfied, the free area size adjustment/data migration determination unit 232 clears the flag (step S26).

The free area size adjustment/data migration determination unit 232 reflects in the information FL22, stored in the data management information recording unit 21, that the data selected for processing in step S2 was checked in step S2 of the current ILM processing as to whether the data can be migrated to another storage area. The information FL22 now indicates that the data was already checked in the current processing.

The processing for the checking target data selected in step S22 is terminated, and control is passed back to step S21 to move data, which can be migrated to another storage area, to solve the problem of an insufficient free area size (step S27).

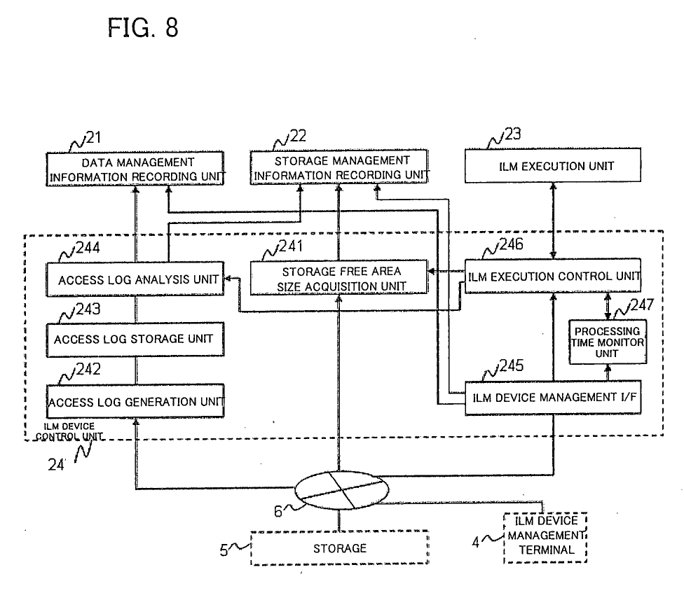

Next, a second example of the present invention will be described. FIG. 8 is a diagram showing the configuration of a system in the second example of the present invention. Referring to FIG. 8, the system configuration of the second example of the present invention is similar to that of the example described above (see FIG. 4) except that a processing time monitor unit 247 is provided in an ILM device control unit 24.

The processing time monitor unit 247 in this example starts and stops the operation, and accepts a setting change, responsive to an instruction from an ILM device management I/F 245.

The processing time monitor unit 247 acquires the operation times of an SLO checking/data migration determination unit 231 and a free area size adjustment/data migration determination unit 232, included in an ILM execution unit 23, from an ILM execution control unit 246 and monitors the acquired times.

When the operation times reach the operation time that was set via the ILM device management I/F 245 in advance, the processing time monitor unit 247 sends an instruction to the ILM execution control unit 246 to stop the operation of the ILM execution unit 23.

In response to the stop instruction from the processing time monitor unit 247, the ILM execution control unit 246 suspends the operation of the SLO checking/data migration determination unit 231 and the free area size adjustment/data migration determination unit 232 of the ILM execution unit 23.

The operation of the second example of the present invention is similar to the operation of the first example except that the function of the processing time monitor unit 247 described above is always in operation.

The present invention allows a system, composed of multiple storage areas, to automatically lay out stored data across the storage areas in such a way that the management requirements of the data are satisfied.

For example, when information must be managed under some regulatory control, the configuration according to the present invention allows the requirements to be reflected directly in the management requirements. This means that the management requirements from outside the system can be directly and automatically reflected in the storage management policy.

As a result, the system according to the present invention reduces the workload of a manager and increases the utilization of storage, thus resulting in a reduction in the storage management cost.

While the present invention has been described with reference to the examples above, it is to be understood that the present invention is not limited to the configuration of the examples above and that modifications and changes that may be made by those skilled in the art within the scope of the present invention are included.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A data arrangement management apparatus that manages arrangement of data in a plurality of storage areas, each of which has a service level (Service Level Agreement, hereinafter termed SLA) assigned, said SLA being a service level guaranteed to data; said apparatus comprising:
means that checks if an SLA of a storage area satisfies a required Service Level Object (hereinafter termed SLO) assigned to data; and
means that, based on the checking result, determines arrangement of data so that data which has a SLO assigned is stored in a storage area whose SLA satisfies the SLO of the data.

2. The apparatus according to claim 1, comprising:
means that checks if an SLA of a storage area where data is stored satisfies an SLO assigned to the data;
means that, if the checking result indicates that the SLA of said storage area does not satisfy the SLO, determines another storage area whose SLA satisfies the SLO of the data; and
means that makes the data stored in the determined another storage area.

3. The apparatus according to claim 1, comprising:
means that checks if an SLA of a storage area where data is stored satisfies an SLO of the data;
means that, if the checking result indicates that the SLA of said storage area does not satisfy the SLO, determines another storage area whose SLA satisfies the SLO of the data; and
means that control to migrate the data from said storage area where the data is stored to the determined another storage area.

4. The apparatus according to claim 1, comprising:
means that, for data which is stored in said storage area and whose SLO may not be satisfied, selectively checks if an SLO of the data is satisfied in a storage area where the data is stored, based on the SLO of the data and the SLA of the storage area; and
means that, if the checking result indicates that the SLO is not satisfied, determines another storage area, which has an SLA satisfying the SLO of the data, from said plurality of storage areas.

5. The apparatus according to claim 1, further comprising:
means that, if there are a plurality of storage area candidates that satisfy the SLO of the data, selects one storage area from the plurality of candidates based on the SLO of the data and the SLA of the storage area.

6. The apparatus according to claim 1, further comprising:
means that performs control such that, if other data cannot be migrated as a result of a migration of the data, the migration of the data is not cancelled and a resolution of an issue that an SLO of the other data, which cannot be migrated, is not satisfied is carried over to next and subsequent data arrangement processing.

7. The apparatus according to claim 4, further comprising:
means that, if there is data which is stored in the storage area and whose SLO may not be satisfied, said data corresponding to at least one of:
data created after the data arrangement processing performed in the storage area;
data whose SLO is changed,
data stored in a storage area whose SLA is changed; and
data whose SLO was not satisfied in the data arrangement processing in the storage area, checks if the SLO of said data is satisfied in the storage area where said data is stored.

8. A data arrangement management system that includes a plurality of storage areas, which configure an HSM (Hierarchical Storage Management) implementation environment, and manages arrangement of information data in said plurality of storage areas by ILM (Information Lifecycle Management), said system comprising:
means that checks if an SLO (Service Level Object) is satisfied in a storage area where data is stored, based on the SLO required by the data and an SLA (Service Level Agreement) of the storage area;
means that, if the checking result indicates that there is data whose SLO is not satisfied, selects a storage area, whose SLA satisfies the SLO, as a migration destination of the data; and
means that migrates the data to the storage area, selected as the migration destination, when the data migration destination storage area is determined.

9. The system according to claim 8, further comprising:
means that holds information on the SLO of the data and the SLA of the storage area.

10. The system according to claim 8, wherein data migration means provided in the HSM implementation environment is used as said means that migrates the data.

11. The system according to claim 8, further comprising:
means that performs control such that, if other data cannot be migrated as a result of the migration of the data, the migration of the data is not cancelled and a resolution of an issue that the SLO of the other data, which cannot be migrated, is not satisfied, is carried over to next and subsequent data arrangement processing.

12. The system according to claim 8, further comprising:
means that, if a free area size of a storage area becomes equal to or smaller than a predetermined value as a result of the data re-arrangement for satisfying the SLO, migrates data stored in the storage area to another storage area within a range, in which the SLO is satisfied, for reserving a free area size in the storage area.

13. The system according to claim 8, further comprising:
means that checks whether the SLA that guarantees the service level of a storage area in which data is stored satisfies the SLO of the data, said data being one of data created after previous data arrangement processing, data whose SLO required by the data is changed, data stored in a storage area whose SLA is changed, and data whose SLO was not satisfied in the previous data arrangement processing.

14. The system according to claim 8, further comprising:
means that, if there are a plurality of storage areas having an SLA that satisfies the SLO of the data, calculates a score based on a difference between a parameter of the SLA of the storage area and a parameter of the SLO of the data to select a storage area as the data migration destination with the score as an evaluation function.

15. The system according to claim 8, wherein the SLO has a parameter target value, which is required to be satisfied as much as possible, and/or a parameter must value which must always be satisfied; and the checking of the SLA is performed separately between the parameter must value and the parameter target value of the SLO.

16. The system according to claim 8, wherein a parameter value of the SLO has an upper limit value and/or lower limit value, which can be taken by the SLO; and the checking of the SLA is performed separately between the upper limit value and the lower limit value of the SLO.

17. The system according to claim 8, wherein whether or not data can be migrated to a storage area is determined by a condition that the SLA of the storage area satisfies the SLO of the data and a free area size of the migration destination storage area does not become insufficient when the data is migrated.

18. The system according to claim 8, further comprising:
means that generates a policy for migrating data so that the SLO of data is satisfied by the SLA of a storage area in which the data is stored.

19. The system according to claim 8, further comprising:
means that performs control such that, when a time required for the data arrangement processing exceeds a predetermined time, defined in advance, at a point in time, the processing is suspended by completing the processing prematurely at the point in time, only data for which the processing has been completed up to the point in time is migrated, and a migration of data that remains unprocessed because of the suspension is carried over to next and subsequent data arrangement processing.

20. The system according to claim 8, further comprising:
means that inhibits migrated data from being migrated to another storage destination during a predetermined period.

21. The apparatus according to claim 1, comprising:
means that, for data stored in a predetermined storage area, checks whether or not there is a storage area having a better SLA that guarantees a service level to the data; and
means that, if the checking result indicates that there is such a storage area, migrates the data to the storage area having a better SLA.

22. The apparatus according to claim 1, comprising:
means that, for entire or a part of data stored in a predetermined storage area, searches storage areas other than the storage area, where the data is currently stored, for another storage area that has a SLA satisfying a required SLO; and
means that, if the checking result indicates that such an storage area is searched for, migrates the data to said another storage area.

23. A data arrangement management system comprising:
a plurality of storage areas, each for storing data;
an ILM device that manages data via ILM (Information Lifecycle Management); and
a data migration execution unit that migrates data between storage areas responsive to an instruction from said ILM device, said plurality of storage areas, said ILM device, and said data migration execution unit being interconnected via a network wherein
said ILM device comprises:
a data management information recording unit that stores a value of a required service level object (Service Level Object, hereinafter termed SLO) of each piece of data stored in said storage areas;
a storage management information recording unit that, for a managed storage area, stores a service level (Service Level Agreement, hereinafter termed SLA) guaranteed to data stored in said storage areas;
an ILM device control unit that controls said ILM device, monitors access to said storage areas, and performs at least one of generation, collection, and analysis of an access log about at least one of a generation, deletion, and update operation on data stored in said storage areas; and
an ILM execution unit, started by an operation instruction from said ILM device control unit, that derives data arrangement that satisfies the SLOs for implementing an ILM-based data management and sends the derived result to said data migration execution unit.

24. The system according to claim 23, wherein
said data management information recording unit stores, for each piece of data stored in said storage areas, an SLO value, a data size, and a storage area where the data is stored and, at the same time, stores an initial value of the SLO assigned to created data and
said storage management information recording unit stores, for each managed storage area, an SLA value guaranteed to data that is stored, a total storage area size, a free area size in the storage area, and a threshold used to determine that the free area size of the storage area is insufficient.

25. The system according to claim 23, wherein
said ILM execution unit comprises:
an SLO checking/data migration determination unit; and
a free area size adjustment/data migration determination unit wherein
said data management information recording unit stores, for each piece of data stored in said storage areas, a flag which is set if the SLO of the data may not be not satisfied, one flag for each piece of data;
the data which is indicated by the flag that the SLO may not be satisfied includes:
data created or data whose SLO parameter is changed, after said ILM device was run last to execute ILM processing; and
data whose SLO was not satisfied when said ILM device was run last to execute ILM processing; and
said data management information recording unit stores, for each piece of data stored in said storage areas, information that indicates when said ILM device checked the SLO of the data last;
wherein
said storage management information recording unit stores, for each storage area included in said storage areas, a flag that is set when the SLA parameter of the storage area is changed after said ILM device executed ILM processing last;
wherein
said SLO checking/data migration determination unit
checks whether each managed storage area included in said storage areas satisfies the SLO and determines a arrangement and a migration destination storage area suitable for storing data, and when the data is to be migrated, issues an instruction to said data migration execution unit to move the data,
notifies said ILM device control unit to start and end an operation and suspends processing when an operation suspension instruction is received from said ILM device control unit,
clears the flag stored in said data management information recording unit which indicates that the SLO of the data may not be satisfied when a possibility that the SLO of data is not satisfied is gone,
updates the information stored in said data management information recording unit, which indicates when the SLO of data was checked last, to indicate that the data was processed in current ILM processing, when processing is performed to find a destination to which data is to be migrated, and
clears the flag that indicates that the SLA of the storage area is changed after immediately preceding ILM processing when processing is terminated, when the flag, which indicates that the SLA of the storage area is changed after said ILM device executed ILM processing last, is set; and
wherein
said free area size adjustment/data migration determination unit
checks, when a free area size of a storage area included in said storage areas is insufficient and data stored in the storage area is migrated to another storage area, whether the SLO of the data is satisfied,
for data whose SLO is satisfied as a result of the checking and which can be migrated to another storage area without causing an insufficiency in a free area size of a migration destination,
instructs said data migration execution unit to move the data to another storage to which the data can be migrated,
notifies said ILM device control unit to start and end an operation,
suspends processing when an operation suspension instruction is received from said ILM device control unit,
clears the flag stored in said data management information recording unit, which indicates that the SLO of the data may not be satisfied, when a possibility that the SLO of data is not satisfied is gone, and
updates the information stored in said data management information recording unit, which indicates when the SLO of the data was checked last, to indicate that the data was processed in current ILM processing, when processing is performed to find a destination to which data is to be migrated.

26. The system according to claim 23, wherein
said ILM device control unit comprises:
a storage free area size acquisition unit;
an access log generation unit;
an access log storage unit;
an access log analysis unit;
an ILM device management interface; and
an ILM execution control unit;
wherein
said storage free area size acquisition unit
acquires a free area size of each storage area from the storage areas via said network and stores a value of the free area size of said each storage area into said storage management information recording unit;
said storage free area size acquisition unit,
suspends or restarts storing information into said storage management information recording unit responsive to an instruction from said ILM execution control unit;
said access log generation unit
monitors said network, generates an access log about data stored in said storage areas, and stores the generated access log and information on storage area loads into said access log storage unit;
said access log storage unit
stores the access log generated by said access log generation unit and provides the stored access log responsive to a request from said access log analysis unit;
said access log analysis unit
reads the access log about data stored in said storage areas from said access log storage unit and analyzes the access log,
detects at least one of a creation, a deletion, and a change in size of data stored in said storage areas and stores the detection result into said data management information recording unit and said storage management information recording unit, and
suspends or restarts storing information into said data management information recording unit responsive to an instruction from said ILM execution control unit;
said ILM device management interface
processes an entered instruction to start or end ILM processing or processes a request to set the ILM device, the SLO of data, and the SLA of a storage area,
when the SLO of data stored in said storage areas is changed, sets a flag because the SLO may not be satisfied when the SLO is changed, and
when the SLA of a storage area included in said storage areas is changed, sets a flag that indicates that the SLA of the storage area is changed; and
said ILM execution control unit controls an operation of said ILM execution unit to generally manage the ILM device, receives an instruction from said ILM device management interface, and starts or ends the operation of said ILM execution unit.

27. The system according to claim 25, wherein
said SLO checking/data migration determination unit reads the SLO of at least one of
data created after immediately preceding ILM processing,
data whose SLO value is changed, and
data stored in a storage area whose SLA is changed from said data management information recording unit, reads the SLA of a storage area, where current data is stored, from said storage management information recording unit, and checks whether the SLO of the data is satisfied in each of the storage areas where data is stored,
for data checked immediately before
compares the SLO of the data, whose SLO is not satisfied, with each of the values of the SLAs representing guarantee service levels of all storage areas
selects a storage area, which has the SLA satisfying the SLO of the data, as a destination to which the data is to be migrated,
instructs said data migration execution unit to move the data when the destination of the data is determined, and
responsive to the instruction to move the data, said data migration execution unit migrates the data to the storage area selected as the destination of migration.

28. The system according to claim 26, wherein
said ILM execution control unit
starts said free area size adjustment/data migration determination unit after the operation of said SLO checking/data migration determination unit is terminated,
said free area size adjustment/data migration determination unit
acquires from said storage management information recording unit, a free area size of each storage area included in the storage areas and a free area size that is a threshold used to determine whether the free area size of each storage area is insufficient and, for each storage area, compares the threshold used to determine whether the fee area size of the storage area is insufficient with an actual free area size,
for a storage area determined that the free area size is insufficient as a result of the comparison, reads data stored in a storage area whose free area size is insufficient and the SLO of the data from said data management information recording unit, and reads the SLA of each storage area included in the storage areas, a current free area size, and a size of the threshold used to determine that the free area of each storage area is insufficient from said storage management information recording unit, in order to solve a problem of the insufficient free area size, and
if, other than the storage area where the data is currently stored, there is a storage area having an SLA that satisfies the SLO of the data and if it is determined that, after the data is migrated, the free area size of the storage area to which the data is migrated does not become insufficient, sends an instruction, which migrates the data to the storage area, to said data migration execution unit.

29. The system according to claim 25, wherein
said ILM device control unit further comprises a processing time monitor unit,
said processing time monitor unit
accepts an instruction, from said ILM device management interface, indicating at least one of an operation start, an operation stop, and a change in settings, and
acquires, from said ILM execution control unit, an operation time of said SLO checking/data migration determination unit and said free area size adjustment/data migration determination unit included in said ILM execution unit, monitors the acquired operation time and, when the operation time reaches an operation time that is set in advance from said ILM device management interface, instructs said ILM execution control unit to stop the operation of said ILM execution unit, and
said ILM execution control unit, responsive to the stop instruction from said processing time monitor unit, suspends the operation of said SLO checking/data migration determination unit and said free area size adjustment/data migration determination unit of said ILM execution unit.

30. A method of managing arrangement of data in a plurality of storage areas, wherein
a service level (Service Level Agreement hereinafter termed SLA), guaranteed by a storage area to data, is assigned to each of said plurality of storage areas, said method comprising:
checking whether the SLA of a storage area, where data is stored, satisfies a required Service Level Object (hereinafter termed SLO) of data to which the SLO is assigned; and
determining data arrangement so that the data is stored in a storage area whose SLA satisfies the SLO.

31. The method according to claim 30, further comprising:
if the SLA of a storage area where data is stored does not satisfy the SLO of the data, selecting a storage area, which satisfies the SLO of the data, from said plurality of storage areas; and
making the data stored in the selected storage area.

32. The method according to claim 30, further comprising:
if a flag, which indicates that there is data whose SLO may not be satisfied, is set for data stored in one storage area, checking whether the SLO is satisfied in the storage area where the data is stored based on the SLO of the data and the SLA of the storage area;
if the checking result indicates that the SLO is not satisfied, determining another storage area whose SLA satisfies the SLO of the data; and
migrating the data from said one storage area to said determined another storage area.

33. A computer program for use in a computer system where a service level (Service Level Agreement hereinafter termed SLA), guaranteed by a storage area to data, is assigned to each of a plurality of storage areas, said program causing said computer system to:
check whether the SLA of a storage area, where data is stored, satisfies a required Service Level Object (hereinafter termed SLO) of data to which the SLO is assigned; and
determine data arrangement so that the data is stored in a storage area whose SLA satisfies the SLO.

34. The program according to claim 33, said program further causing said computer system to:
if the SLA of a storage area where data is stored does not satisfy the SLO of the data, select a storage area, which satisfies the SLO of the data, from said plurality of storage areas; and
make the data stored in the selected storage area.

35. The program according to claim 33, said program further causing said computer system to:
if a flag, which indicates that there is data whose SLO may not be satisfied, is set for data stored in one storage area, check whether the SLO is satisfied in the storage area where the data is stored based on the SLO of the data and the SLA of the storage area;
if the checking result indicates that the SLO is not satisfied, determine another storage area whose SLA satisfies the SLO of the data; and
migrate the data from said one storage area to said determined another storage area.
